(19) United States
(12) Patent Application Publication
(10) Pub. No.: US 2023/0420196 A1
(43) Pub. Date: Dec. 28, 2023

(54) TEMPERATURE SENSING DEVICE FOR A HIGH VOLTAGE DISCONNECTING SWITCH AND HIGH VOLTAGE DISCONNECTING SWITCH INCLUDING A TEMPERATURE SENSING DEVICE

(71) Applicant: Weinert Industries AG, Foritztal (DE)

(72) Inventors: Juntao Deng, Changzhou, Jiangsu (CN); Wei Lu, Changzhou, Jiangsu (CN)

(73) Assignee: Weinert Industries AG, Foritztal (DE)

(21) Appl. No.: 18/035,505

(22) PCT Filed: Nov. 5, 2020
(86) PCT No.: PCT/CN2020/126699

§ 371 Date: May 4, 2023

(51) Int. Cl. H01H 11/00; G01K 11/3213; G01K 1/16

(52) U.S. Cl. CPC H01H 11/0062; G01K 11/3213; G01K 1/16; H01H 2011/0068

(57) ABSTRACT

A sensing device for a high voltage disconnecting switch comprises a light emitting element, which is configured to align its temperature with a temperature of the high voltage disconnecting switch, and an optical fiber, which is configured to receive a light emission from the light emitting element and configured to guide the light emission. Further, a deriving unit is configured to receive the light emission from the optical fiber and derive information about the temperature of the high voltage disconnecting switch based on a duration of the received light emission.

In the following, a temperature sensing device for a high voltage disconnecting switch and high voltage disconnecting switch including a temperature sensing device are described.

Progressive energy supply systems, which provide electrical energy to a plurality of spaced apart users, are based on decentral power generation units such as wind energy plants, combined heat and power stations, solar energy units and small entity power plants. However, decentral power deployment and consumption require enhanced power grids for distributing electrical energy, wherein the enhanced power grids include a plurality of substations, which intermittently connect or disconnect high voltage linkages to route the electrical energy.

The connecting and disconnecting of high voltage linkages is commonly realized with breaking-closing disconnecting switches, BCDS, which are indispensable but error sensitive components of power grid substations.

A common malfunction of known BCDS is caused by erroneous or incomplete contacting of high voltage contacting means of a BCDS, e.g. due to soiled or mechanically deformed contacting means. A resulting poor electrical connection between the high voltage contacting means causes a significantly increased electrical resistance of the BCDS and, therefore, an increasing of the temperature of the operated BCDS. In result, a risk of an accident as well as a loss of electrical energy are enormously increased.

Therefore, frequently inspecting and monitoring the temperature of a BCDS, particularly the temperature of high voltage contacting means of a BCDS, is essential for ensuring the effective operation of a substation and a power grid including the substation, enhancing the operational safety and reducing downtimes.

For measuring, monitoring and/or reporting a temperature of technical devices, several methods and sensing devices are known. However, known temperature measurement devices include an electrically operated component, at least for transmitting a measured temperature value to a centralized monitoring or evaluation unit. Such electrically operated devices are inadequate for the use in the immediate vicinity of high voltage contacting means since the voltage difference between the contacting means and a sensor electrode (ground level to >50 kV at the sensor position) would render an operability of the sensing device impossible, but at least influence the operability of the sensing device.

Further, substations and its components such as BCDS are commonly exposed to environmental influences such as varying surrounding temperature, humidity, air pressure and wind conditions and/or a deposition of dust or pollution.

Hence, a temperature sensing device for a high voltage disconnecting switch must be resilient to common environmental influences under which substations are to be operated and must not require components which are to be electrically operated in the near vicinity of a high voltage disconnecting switch.

A solution for this technical problem is provided by a sensing device according to independent claim 1 and a high voltage disconnecting switch according to independent claim 12. Further embodiments of the sensing device and the high voltage disconnecting switch are defined by claims 2 to 11 and 13 to 15.

A sensing device for a high voltage disconnecting switch comprises a light emitting element, which is configured to align its temperature with a temperature of the high voltage disconnecting switch, and an optical fiber, which is configured to receive a light emission from the light emitting element and configured to guide the light emission. Further, a deriving unit is configured to receive the light emission from the optical fiber and derive information about the temperature of the high voltage disconnecting switch based on a duration/temporal extent of the received light emission.

The light emitting element is configured to emit light emissions. The light emissions, which are emitted by the light emitting element and/or guided by the optical fiber, may comprise ultraviolet light, visible light and/or infrared light.

The light emitting element can be configured to emit light emissions based on its temperature and/or based on the temperature of the high voltage disconnecting switch. Corresponding to the temperature of the light emitting element and/or the high voltage disconnecting switch, the light emissions may vary in intensity, duration, width of frequency spectrum and/or frequency distribution/composition. In other words, the temperature of the light emitting element and/or the high voltage disconnecting switch can influence the characteristics or physical parameters of a light emission, which is emitted by the light emitting element and/or guided by the optical fiber. The temperature of the light emitting element and/or the high voltage disconnecting switch can influence the intensity, the duration, the width of a frequency spectrum and/or a frequency distribution/composition of the light emission.

The optical fiber can comprise a silica material, in particular a glass material, and/or a polymer material. Further, the optical fiber can be coupled to the light emitting element and/or the optical fiber can be coupled to the deriving unit. The optical fiber can be partially coated or surrounded by a coating or surrounding material, e.g. with a polymer material.

The deriving unit can be coupled with the optical fiber and/or further configured to derive information about the temperature of the high voltage disconnecting switch based on an intensity and/or a frequency spectrum and/or a frequency distribution of the received light emission, which has been emitted by the light emitting element and and/or guided by the optical fiber. The deriving unit can comprise at least one optoelectronic element and/or an integrated circuit. Further, the deriving unit can be configured to be coupled with a data processing system, e.g. with a control and/or monitoring system of a high voltage disconnecting switch and/or of a substation. Optionally, the deriving unit can be integrated into a data processing system.

An advantage of the sensing device is that the light emitting element and the optical fiber, i.e. the elements which must at least partially be arranged in the immediate vicinity of high voltage contacting means, can be operated without transmission of electrical energy. Thus, a malfunction of the sensing device due an electromagnetic influence in the vicinity of the high voltage disconnecting switch can be excluded.

Another advantage is that the sensing device can be implemented without any moveable elements and/or with additional isolation and/or protection means such as a polymer coating which seals the sensing device. Thus, the sensing device can be effectively protected against environmental influence.

Optionally, the sensing device for a high voltage disconnecting switch comprises a contact element configured to be arranged on a surface, particularly on a metal surface, of the contacting means of the high voltage disconnecting switch and configured to align with a temperature of the surface.

The light emitting element and/or the optical fiber can be disposed on a surface of the contact element. Alternatively or complementary, the light emitting element and/or the optical fiber can be at least partially enclosed by the contact element.

Optionally, the contact element comprises a plastic or polymer material and/or a metal material, e.g. a copper material.

Further, the contact element can comprise a cylindrical-shaped portion, and/or a ring-shaped portion.

The light emitting element and/or the optical fiber can be configured to align with a temperature of the surface of the high voltage disconnecting switch and/or to align with a temperature of the contact element.

An advantage of the contact element is that it enhances and simplifies a positioning of the light emitting element at the high voltage disconnecting switch, particularly on a metal surface of the contacting means of the high voltage disconnecting switch.

The contact element can be shaped corresponding to existing means of a high voltage disconnecting switch, e.g. corresponding to existing isolation and/or spacing means of a high voltage disconnecting switch. In a variant, the contact element can have a ring shaped portion and be configured to be arranged around a spacing element, which is arranged between a high voltage contact element and a spring that presses the high voltage contact element to another high voltage contact element to enhance an electrical conductive contact between these elements.

Another advantage of the contact element is that it enhances a temperature alignment between the light emitting element and the high voltage disconnecting switch.

Even another advantage of the contact element is that it can protect the light emitting element from environmental influences, e.g. by at least partially enclosing the light emitting element.

Optionally, the light emitting element can be a coating, which is disposed on a surface or on a part of a surface of the optical fiber. In a variant, the light emitting element can be a coating, which covers a part of the surface of the optical fiber, wherein the coated part of the optical fiber is enclosed by the contact element.

Further, the light emitting element can include/comprise luminescent, particularly photoluminescent, substance/material, e.g. a phosphor substance/material which includes/comprises oxides, nitrides, oxynitrides, sulfides, selenides, halides and/or silicates of zinc, cadmium, manganese, aluminium, silicon and/or rare-earth metals.

In a variant, the light emitting element is a photoluminescent coating, which is disposed on a part of the optical fiber.

In a variant, the sensing device for a high voltage disconnecting switch further comprises a light source, which is configured to intermittently emit light. The optical fiber can be configured to receive the light, which is emitted by the light source, and to guide the light, which emitted by the light source. The light emitting element can be configured to absorb energy of the light, which is emitted from the light source and guided by the optical fiber.

An advantage of a light emitting element comprising (photo)luminescent substance is that the (photo)luminescent material can be supplied with energy by intermittently guiding light from a light source through the optical fiber without a transmission of electrical energy. When the luminescent substance absorbs the energy of the light from the light source, electrons inside the luminescent substance will have the phenomenon of energy level transition, which generates a luminescence phenomenon, i.e. fluorescence. When the intermittently provided light from the light source temporarily fades, the luminescence will disappear in a period, wherein the temporal extent of this period depends on the temperature of the light emitting element, i.e. the temperature of the luminescent substance. Hence, the deriving unit can receive the light emission from the light emitting element through the optical fiber and derive information about the temperature of the high voltage disconnecting switch based on a duration of the received light emission caused by the luminescent substance.

In a variant, the sensing device can comprise a mirroring component and/or a focusing optics, wherein the mirroring component can be coupled to an end of the optical fiber and/or the focusing optics can be arranged between the optical fiber and the deriving unit. The deriving unit can configured to receive a focused light emission from the optical fiber and the deriving unit can configured to derive the information about the temperature of the high voltage disconnecting switch based on the received focused light emission.

An advantage of the mirroring component, which can be coupled to an end of the optical fiber, particularly an end of the optical fiber that opposes an end of the optical fiber coupled with the deriving unit, is that a light emission of the light emitting element can be reflected. Thus, an intensity of a light emission received by the deriving unit can be enhanced.

An advantage of the focusing optics is that a light emission of the light emitting element can be focused for an evaluation by the deriving unit. Thus, an intensity of a light emission received by the deriving unit can be enhanced.

Optionally, the sensing device, particularly the deriving unit, can comprise an alert module, which is configured to output an alert message if a high voltage disconnecting switch temperature, which is determined by the deriving unit, exceeds a threshold. The alert message can be an optical and/or acoustical alert, which is transmitted be optical and/or acoustical alert means. Alternatively or complementary, the alert Message can be an electronically transmittable data message to an extremal or integrated data processing system, which is coupled to the sensing device, particularly the deriving unit.

A high voltage disconnecting switch may comprise a sensing device as described above.

Beyond the above described sensing device, the high voltage disconnecting switch can further comprise at least two high voltage connecting means, which are configured to be position spaced apart from each other and which are configured to be positioned in contact with each other, thereby disconnecting a high voltage link and establishing a high voltage link, respectively. For contacting each other, at least one of the connecting means may comprise contact segments.

Further, the high voltage disconnecting switch can comprise a spring, which is configured to deform when the switching state of the high voltage disconnecting switch changes (i.e. a high voltage link is established or disconnected), thereby supporting an intended positioning the high voltage connecting means and/or the contact segments.

The sensing device can, at least partially, be arranged between the spring of the disconnecting switch and the connecting means and/or contact segments of the disconnecting switch, wherein the light emitting element and/or the contact element can be configured to separate and/or electrically isolate the spring from the connecting means and/or the contact segments.

An advantage of this arrangement is, that the sensing device can be integrated into a high voltage disconnecting switch that comprises a spring, thereby fixed in close contact with the connecting means and/or the contact segments of the connecting means and additionally providing the bonus effect of a separation and/or isolation element, which has to be provided for the disconnecting switch comprising a spring.

Thus, the sensing device can be arranged without impact to design of the high voltage disconnecting switch merely by replacing existing separation and/or isolation means of the disconnecting switch.

In another variant, the sensing device can be shaped and/or positioned around a spacing element between the spring of the high voltage disconnecting switch and the connecting means and/or the contact segments of the connecting means of the high voltage disconnecting switch. Thus, the sensing device can be adapted to existing separation and/or isolation means of the disconnecting switch, thereby minimizing effort for upgrading and/or redesigning existing high voltage disconnecting switches.

The high voltage disconnecting switch as such can be a breaking-closing disconnecting switch, BCDS, a centre break disconnecting switch, a double break disconnecting switch, a vertical break disconnecting switch, a panthograph disconnecting switch, a semi-panthograph disconnecting switch or a knee type disconnecting switch.

To enhance the understanding of the arrangement described afore the following figures are provided:

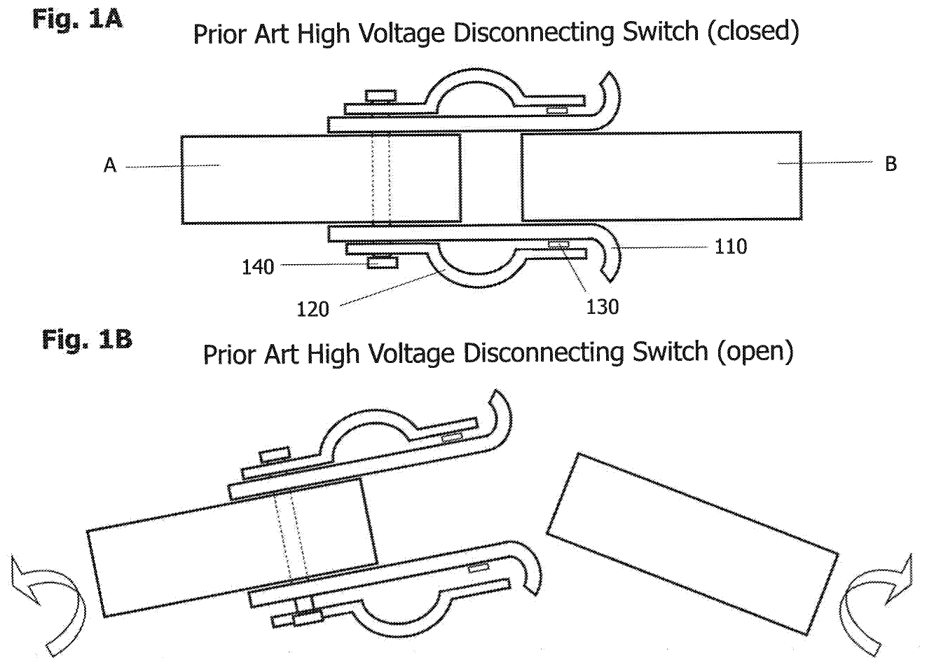

FIG. 1A/B schematically shows an example for a high voltage disconnecting switch, comprising two connecting means.

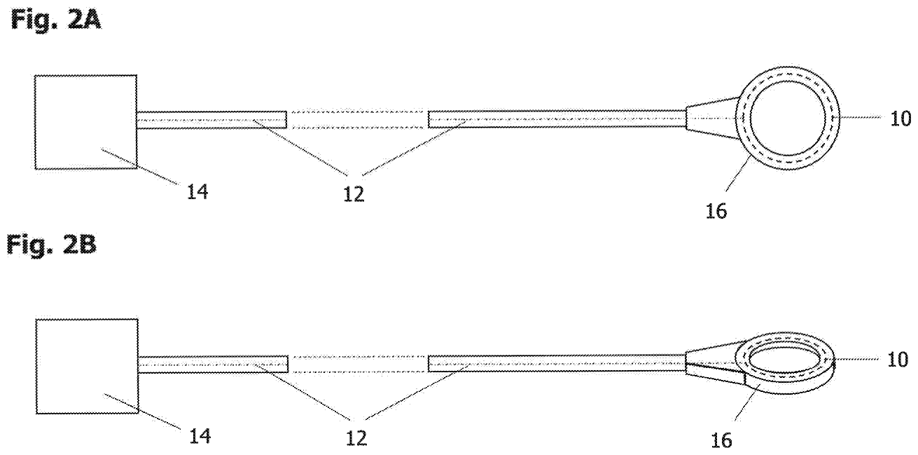

FIG. 2A/B schematically shows an example for sensing device for a high voltage disconnecting switch.

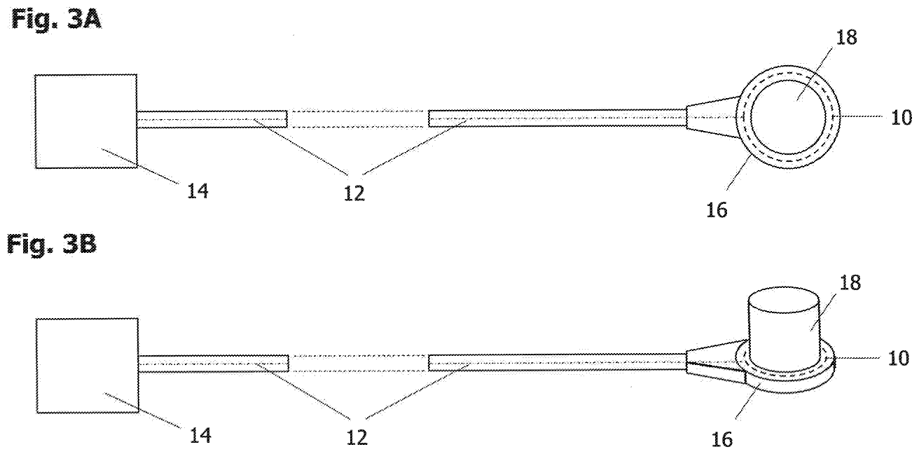

FIG. 3A/B schematically shows another example for sensing device for a high voltage disconnecting switch.

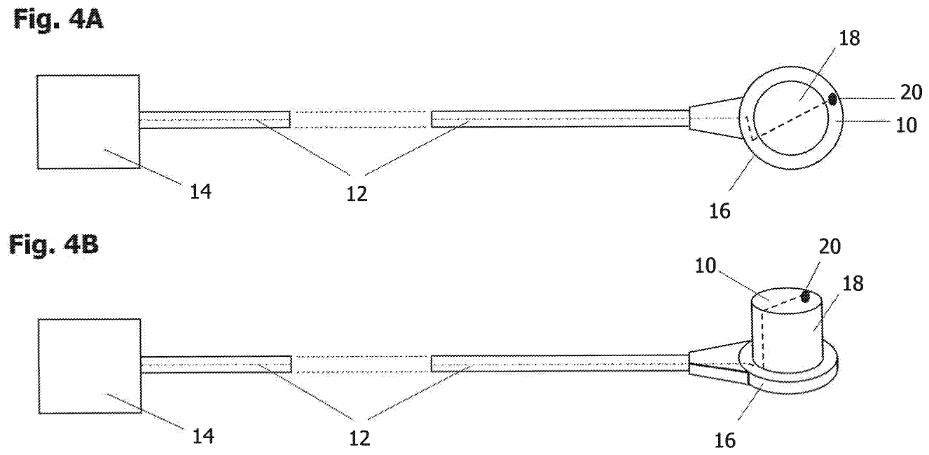

FIG. 4A/B schematically shows yet another example for sensing device for a high voltage disconnecting switch.

If not explicitly described contrary, identical reference signs used in the drawing describe corresponding or similar components used for the different implementations. Further, to enhance clarity of the implementations shown, not all figures comprise reference signs for all elements shown.

FIG. 1A/B shows an example for a high voltage disconnecting switch, comprising the high voltage connecting means A, B. The two high voltage connecting means A, B are configured to be position spaced apart from each other (FIG. 1B) and are configured to be positioned in contact with each other (FIG. 1A), thereby disconnecting a high voltage link and establishing a high voltage link, respectively. For establishing an electric conductive connection between the connecting means A, B, contact segments 110 are fixed to one of the connecting means.

Further, the shown high voltage disconnecting switch comprises the springs 120, which are also fixed to one of the connecting means. The springs 120 provide a mechanical pressure to a contact zone of the contact segments 110 thereby supporting the electric conductive connection between the connecting means A, B in the closed switch state (FIG. 1A).

As shown in FIG. 1A/B, the contact segments 110 as well as the springs 120 are fixed to one of the connecting means with a fixation element 140. However, in the vicinity of the contact zone of the contact segments 110, the springs 120 and contact segments 110 are spaced apart from each other by a cylindrical separation element 130, which comprises a non-conductive plastic material.

FIG. 2A/B shows an example for a sensing device, which is configured to determine a temperature of the high voltage disconnecting switch, without transmission of electrical energy in the close vicinity of the high voltage disconnecting switch.

The shown sensing device comprises a contact element 16, which is configured to be arranged on a surface of the high voltage disconnecting switch, i.e. a surface of the connecting means A, B and/or a surface of the contact segments 110.

In the variant shown in FIG. 2A/B, the contact element 16 is a ring-shaped copper element, which comprises a high thermoconductivity. Hence, the contact element 16 promptly aligns its temperature to the temperature of a surface on which the contact element 16 is arranged.

Further, the shown sensing device comprises a light emitting element 10, which is enclosed by the ring-shaped the contact element 16. The light emitting element 10 is configured to align its temperature with the temperature of contact element 16 and, thus, with the temperature of the surface on which the contact element 16 is arranged.

In the variant shown in FIG. 2A/B the light emitting element 10 is a photoluminescent coating disposed on a surface of an optical fiber 12. The optical fiber 12 extends through the contact element 16 and is configured to receive a light emission from the light emitting element 10, i.e. the photoluminescent coating, and configured to guide the light emission. Further, the fiber 12 is coupled to a deriving unit 14, which is configured to receive light emissions from the optical fiber 12 and derive information about the temperature of the light emitting element 10 and, thus, the temperature of the contact element 16 and the temperature of the surface on which the contact element 16 is arranged, based on a duration of the received light emission.

A light source (not shown) is configured to intermittently emit light through the optical fiber 12. The photoluminescent coating 10 is configured to absorb energy of the light, which is emitted from the light source and guided through the optical fiber 12. Thus, the photoluminescent coating 10 is supplied with energy from the light source through the optical fiber without a transmission of electrical energy.

When the photoluminescent coating 10 absorbs the energy of the light from the light source, electrons inside the photoluminescent coating 10 have the phenomenon of an energy level transition that generates fluorescence. When the intermittently provided light from the light source is temporarily faded, the luminescence disappears in a certain period, wherein the temporal extend of this period depends on the temperature of the coating, i.e. the temperature of the surface on which the contact element 16 is arranged. Hence, the deriving 14 unit can receive the light emission from the light emitting element through the optical fiber 12 and derive information about the temperature the surface on which the contact element 16 is arranged based on the duration of the received light emission.

As shown in FIG. 2A/B, a sensing device can be designed corresponding to a shape of the cylindrical separation element 130. Thus the sensing device shown in FIG. 2A/B can be arranged easily between a spring 120 and a contact segment 110 of a high voltage disconnecting switch and allows measuring a temperature of the disconnecting switch, particularly a temperature of the relevant contact zone of the connecting means A, B, without transition of electrical energy in the near vicinity of the high voltage disconnecting switch.

As shown in FIG. 3A/B, the contact element 16 of the sensing device can also comprise a cylindrical-shaped portion 18, which comprises a plastic material. The sensing device shown in FIG. 3A/B is to be operated the same way as the sensing device shown in FIG. 2A/B but may replace the separation element 130 shown in FIG. 1A/B instead of being arranged to it.

Further, as shown in FIG. 4A/B, the light emitting element 10, which is coupled with and/or disposed on the optical fiber 12, can extend through distinguished portions of the contact element 16. When the light emitting element 10 is disposed on the optical fiber 12, the optical fiber 12 can extend through distinguished portions of the contact element 16. For example, the light emitting element 10 and/or the optical fiber 12 may form a closed or open loop. Optionally, an end of the light emitting element 10 and/or the optical fiber 12 may be coupled to a mirroring component 20, which is configured to reflect light emitted by the light emitting element 10. Thus, an intensity of the light emission received by the deriving unit can be enhanced.

Conclusively, it is emphasized that the subject-matter shown in the figures does not limit the subject-matter claimed and does merely serve to enhance the understanding of the disclosure. However, the features shown in the figures and described above are included in the disclosure and can explicitly be combined with further features of the disclosure.

1. A sensing device for a high voltage disconnecting switch, the sensing device comprising:
a light emitting element configured to align its temperature with a temperature of the high voltage disconnecting switch;
an optical fiber configured to receive a light emission from the light emitting element and configured to guide the light emission;
a deriving unit configured to receive the light emission from the optical fiber and derive information about the temperature of the high voltage disconnecting switch based on a duration of the received light emission.

2. The sensing device of claim 1, further comprising
a contact element configured to be arranged on a surface of the high voltage disconnecting switch and configured to align with a temperature of the surface, wherein
the light emitting element and/or the optical fiber is disposed on a surface of the contact element, and/or wherein
the light emitting element and/or the optical fiber is enclosed by the contact element.

3. The sensing device of claim 2, wherein
the contact element includes a plastic material, and/or
the contact element includes a metal material, and/or
the contact element comprises a cylindrical-shaped portion, and/or
the contact element comprises a ring-shaped portion.

4. The sensing device of any one of claims 1 to 3, wherein
the light emitting element and/or the optical fiber is configured to align with a temperature of the surface of the high voltage disconnecting switch and/or to align with a temperature of the contact element.

5. The sensing device of any one of claims 1 to 4, wherein
the light emitting element is a coating disposed on a surface of the optical fiber.

6. The sensing device of any one of claims 1 to 5, wherein
the light emitting element includes a luminescent substance.

7. The sensing device of any one of claim 6, further comprising
a light source configured to intermittently emit light, wherein
the optical fiber is further configured to receive light emitted by the light source and further configured to guide the light emitted by the light source, and wherein
the light emitting element is further configured to absorb energy of the light, which is emitted from the light source and guided by the optical fiber.

8. The sensing device of any one of claims 1 to 7, wherein
the deriving unit is further configured derive information about the temperature of the high voltage disconnecting switch based on an intensity and/or
a frequency spectrum and/or a frequency distribution of the received light emission.

9. The sensing device of any one of claims 1 to 8, further comprising
a mirroring component and/or a focusing optics, the mirroring component coupled to an end of the optical fiber and/or the focusing optics arranged between the optical fiber and the deriving unit, and/or wherein
the deriving unit is configured to receive a focused light emission from the optical fiber and the deriving unit is configured to derive the information about the temperature of the high voltage disconnecting switch based on the received focused light emission.

10. The sensing device of any one of claims 1 to 9, further comprising
an alert module configured to output an alert message if a high voltage disconnecting switch temperature, which is determined by the deriving unit, exceeds a threshold.

11. The sensing device of any one of claims 1 to 10, wherein
the light emitting element and/or the contact element is further configured to be arranged between a spring of the high voltage disconnecting switch and contacting means of the high voltage disconnecting switch, and/or wherein
the light emitting element and/or the contact element is further configured to separate and/or electrically isolate the spring from the contacting means.

12. A high voltage disconnecting switch comprising the sensing device according to any one of claims 1 to 11.

13. The high voltage disconnecting switch of claim 12, the high voltage disconnecting switch further comprising
a spring configured to elastically deform when a switching state of the high voltage disconnecting switch changes, wherein
the sensing device is partially arranged between a spring of the high voltage disconnecting switch and contacting means of the high voltage disconnecting switch, and/or wherein
the light emitting element and/or the contact element is further configured to separate and/or electrically isolate the spring from the contacting means.

14. The high voltage disconnecting switch of claim 12 or 13, wherein
the sensing device is shaped around a spacing element between the spring of the high voltage disconnecting switch and the contacting element of the high voltage disconnecting switch.

15. The high voltage disconnecting switch of any one of claims 12 to 14, wherein the high voltage disconnecting switch is configured as a breaking-closing disconnecting switch, BCDS, a centre break disconnecting switch, a double break disconnecting switch, a vertical break disconnecting switch, a panthograph disconnecting switch, a semi-panthograph disconnecting switch or a knee type disconnecting switch.
